(19) United States
(12) Patent Application Publication
(10) Pub. No.: US 2008/0017734 A1
(43) Pub. Date: Jan. 24, 2008

(54) System and method of uniform spray coating

(76) Inventors: Paul R. Micheli, Glen Ellyn, IL (US); Christine Laub, Carol Stream, IL (US); Al Suopys, Lindenhurst, IL (US); Michael Starozhitsky, Long Grove, IL (US)

Correspondence Address: Tait R. Swanson;FLETCHER YODER, P.O. Box 692289, Houston, TX, 77269-2289, US

(21) Appl. No.: 11/484,320

(22) Filed: Jul. 10, 2006

(51) Int. Cl. B05B 1/28

(52) U.S. Cl. 239/296; 239/1; 239/526; 239/597

(57) ABSTRACT

In certain embodiments, a method includes microblasting a spray tip of a spray device to refine spray characteristics of the spray tip. In other embodiments, a method includes outputting a substance from a microblasted output orifice of a spray device to create a spray having characteristics at least partially attributed to a microblast treatment of the microblasted output orifice; and applying the spray onto a surface of a product to create a coating having characteristics at least partially attributed to the microblast treatment.

### BACKGROUND

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Spray devices, such as spray guns, often included imperfections on the surfaces of fluid passages and orifices. For example, the primary fluid orifice often has grind lines, burrs, and other undesirable surface imperfections. Unfortunately, these surface imperfections can cause undesirable spray characteristics, such as a non-uniform distribution of fluid droplets downstream of the spray device. For example, the spray may exhibit a finger like pattern, which has alternating high density and low density regions of fluid droplets. In spray coating applications, this non-uniformity in the spray also results in undesirable characteristics in the coating applied by the spray device. For example, the coating may have a non-uniform thickness, which may be attributed to the finger like pattern in the spray.

### BRIEF DESCRIPTION

In certain embodiments, a method includes microblasting a spray tip of a spray device to refine spray characteristics of the spray tip. In other embodiments, a method includes outputting a substance from a microblasted output orifice of a spray device to create a spray having characteristics at least partially attributed to a microblast treatment of the microblasted output orifice; and applying the spray onto a surface of a product to create a coating having characteristics at least partially attributed to the microblast treatment.

### DRAWINGS

These and other features, aspects, and advantages of the present invention will become better understood when the following detailed description is read with reference to the accompanying drawings in which like characters represent like parts throughout the drawings, wherein:

FIG. 1 is a perspective view of an embodiment of a spray device having a spray tip with generally uniform spray characteristics attributed at least partially to a microblast treatment of the spray tip;

FIG. 2 is a cross-sectional view of the spray device as illustrated in FIG. 2;

FIG. 3 is a partial cross-sectional view of the spray device as illustrated in FIGS. 1 and 2;

FIG. 4 is a flow chart of an exemplary process for manufacturing a spray tip of the spray device as illustrated in FIGS. 1-3;

FIG. 5 is a cross-sectional view of the spray tip as illustrated in FIGS. 1-3, further illustrating a grinding mechanism exploded from a desired location for a fluid output orifice in the spray tip in accordance with the process as illustrated in FIG. 4;

FIG. 6 is a cross-sectional view of the spray tip as illustrated in FIGS. 1-3 and 5, further illustrating a fluid output orifice in the spray tip as a result of the grinding procedure as illustrated in FIGS. 4 and 5;

FIG. 7 is a perspective view of the spray tip as illustrated in FIG. 6, further illustrating various grind lines, burrs, and other undesirable surface features prior to a microblasting procedure as illustrated in FIG. 4;

FIG. 8 is a top view of the spray tip as illustrated in FIG. 7;

FIG. 9 is a cross-sectional view of the spray tip as illustrated in FIGS. 1-3 and 6-8, further illustrating a microblast nozzle applying a microblast media stream into the fluid output orifice in accordance with a microblasting procedure of the process illustrated in FIG. 4;

FIG. 10 is a top view of the spray tip as illustrated in FIGS. 1-3 and 6-9, further illustrating refined surface features of the fluid output orifice after the microblasting procedure as illustrated in FIGS. 4 and 9;

FIG. 11 is a block diagram of an exemplary system for performing a microblasting procedure on the spray tip as illustrated in FIGS. 4-9;

FIG. 12 is a flow chart of an exemplary process for spray coating a product using a spray tip having a microblasted orifice and/or fluid passages in accordance with a microblasting procedure as illustrated in FIGS. 4 and 9;

FIG. 13 is a cross-sectional view of the spray tip as illustrated in FIGS. 1-3 and 6-10, further illustrating improvement in a spray from the spray tip after a microblasting procedure as illustrated in FIGS. 4 and 9; and

FIG. 14 is a partial cross-sectional view of a product coated by the spray of FIG. 13, further illustrating an improvement in a spray coating layer after a microblasting procedure as illustrated in FIGS. 4 and 9.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

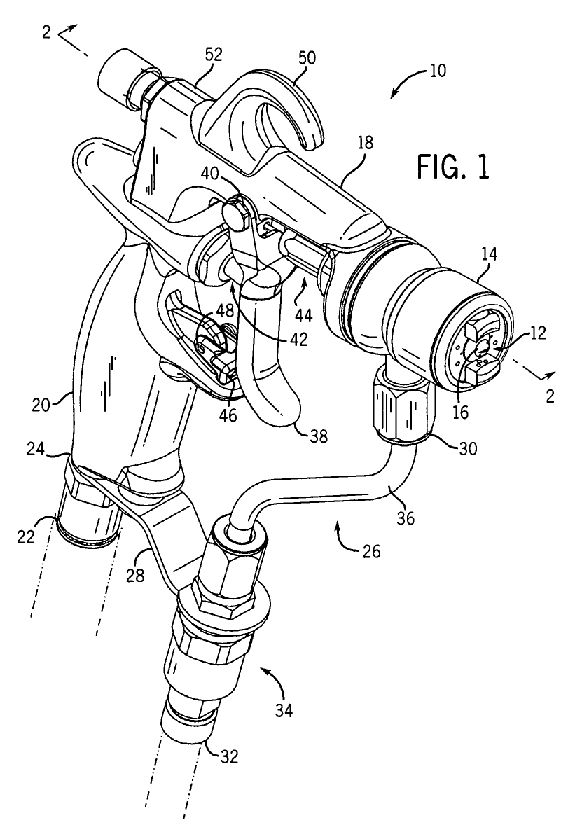

FIG. 1 is a perspective view of an embodiment of a spray device 10 having a spray tip 12 disposed within a head assembly 14, wherein the spray tip 12 has generally uniform spray characteristics attributed at least partially to a microblast treatment of the spray tip 12 as discussed in further detail below. As a result, the spray generated by the spray tip 12 produces a substantially improved or more uniform coating on a product. In certain embodiments, the spray device 10 is an airless spray coating gun or an air-assisted spray coating gun, which generally atomize the liquid without air atomization mechanisms. However, an air-assisted spray coating gun may include air jets configured to shape the liquid spray in the desired pattern, e.g., flat, conical, hollow, and so forth. In other embodiments, the spray device 10 may be an air atomization spray gun, which includes one or more air jets configured to atomize the liquid. The air atomization spray gun also may include one or more spray shaping jets as mentioned above.

As discussed in further detail below, the spray tip 12 includes one or more internal cavities, passages, or pathways leading to a fluid output orifice 16, such as a cat-eye orifice (e.g., orifice having a generally cat-eye or oval shape). The spray device 10 selectively passes a fluid, such as paint, lacquer, wood stain, or another coating liquid, through the fluid output orifice 16 to create a fluid spray. In the disclosed embodiments, the fluid output orifice 16 is subjected to a microblast treatment to improve or refine the surface characteristics of the fluid output orifice 16, thereby improving the fluid spray and subsequent coating applied to a particular product. For example, the microblast treatment may at least substantially or entirely remove grind lines, burrs, machining marks, and various surface defects or non-uniformities in the fluid output orifice 16 and one or more passages, chambers, and so forth. In this manner, the fluid spray created by the spray tip 12 has a substantially improved spray pattern or uniformity. For example, the fluid spray may be substantially more uniform in density, shape, and general distribution of the atomized liquid, thereby substantially improving the uniform application of the fluid onto a target surface.

As further illustrated in FIG. 1, the head assembly 14 is coupled to a body assembly 18 of the spray device 10. The illustrated body assembly 18 includes a handle 20 and an air supply coupling 22 disposed at a base 24 of the handle 20. The body assembly 18 also includes a liquid supply assembly 26 coupled to the base 24 of the handle 20 via a bracket 28. The liquid supply assembly 26 is further coupled to the head assembly 14 via a liquid head coupling 30. The illustrated liquid supply assembly 26 includes a liquid supply coupling 32, a liquid filter assembly 34, and a liquid conduit 36 leading to the liquid head coupling 30. The body assembly 18 also includes a trigger 38 rotatably coupled to a pivot joint 40. In turn, the trigger 38 is movably coupled to an air valve assembly 42 and a liquid valve assembly 44, such that the trigger simultaneously controls the passage of air and liquid through the spray device 10. In addition, the body assembly 18 includes a trigger lock 46 rotatably coupled to a pivot joint 48 in close proximity to the trigger 38. The trigger lock 46 enables a user to lock or unlock the trigger 38 and, as a result, the associated air and liquid valve assemblies 42 and 44. The illustrated body assembly 18 also includes a hanging support or hook 50 disposed along a top 52 of the spray device 10.

In certain embodiments, the spray device 10 may further include air and liquid conduits leading to the air and liquid supply couplings 22 and 32. In an exemplary spray system, a plurality of the spray devices 10 may be coupled to one or more positioning systems, control units, user interfaces, computers, and so forth. For example, an exemplary positioning system may include one or more robotic arms, overhead rail structures having moving supports, or combinations thereof. In some applications, the spray guns 10 may be coordinated with one another to perform a desired spraying operation, such as spraying a plurality of automobiles in an assembly line. The spraying system also may include associated systems and devices, such as infrared heaters or other curing devices configured to cure a spray coating.

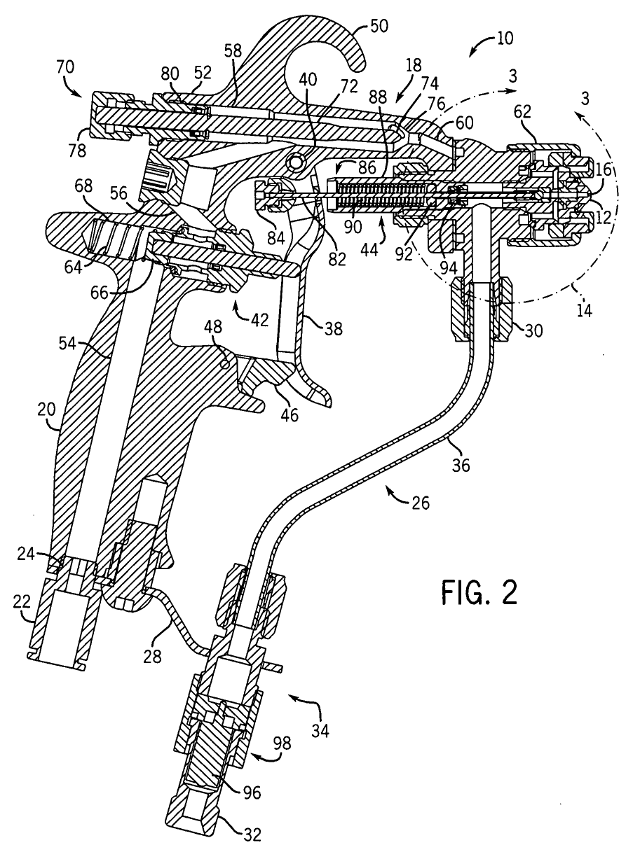

FIG. 2 is a cross-sectional view of an embodiment of the spray device 10 as illustrated in FIG. 1, further illustrating internal components and flow passages through the head and body assemblies 14 and 18. As illustrated, the body assembly 18 includes a series of air passages 54, 56, 58, and 60 leading from the air supply coupling 22 to an air nozzle assembly 62 of the head assembly 14. The air valve assembly 42 is disposed between the air passages 54 and 56 to control the passage of air via operation of the trigger 38. As illustrated, the air valve assembly 42 includes a spring 64 disposed adjacent a moveable valve member 66, which move linearly along a valve channel 68 as the trigger 38 rotates about the pivot joint 40.

Downstream from the air valve assembly 42, a pressure or flow control assembly 70 is disposed along the air passage 58. The pressure or flow control assembly 70 includes an adjustment valve 72 having a wedge-shaped valve tip 74 disposed near a wedged portion 76 of the air passage 58. The pressure or flow control assembly 70 also includes an adjustment head 78 coupled to the adjustment valve 72 and rotatably coupled to the body assembly 18 via threads 80. Accordingly, the adjustment head 78 may be rotated to change the linear distance or proximity of the wedge-shaped valve tip 74 relative to the wedged portion 76 of the air passage 58. In this manner, the pressure or flow control assembly 78 can adjust the rate or pressure of air flow to the air nozzle assembly 62.

In addition to airflow, the trigger 38 rotates about the pivot joint 40 to open and close the liquid valve assembly 44, which extends through the head assembly 14 to the spray tip 12. In the illustrated embodiment, the liquid valve assembly 44 includes a valve shaft 82 coupled to the trigger 38 via a fastener 84. The liquid valve assembly 44 also includes a needle packing cartridge assembly 86 disposed about the valve shaft 82 and threadingly coupled to the head assembly 14. The illustrated needle packing cartridge assembly 86 includes a cylindrical casing 88 and an internal coil spring 90 disposed about the valve shaft 82. The needle packing cartridge assembly 86 also includes one or more seals, such as o-ring seals 92 and 94.

In operation, as the trigger 38 rotates clockwise about the pivot joint 40, the valve shaft 82 is biased linearly to the left to an open position that enables the passage of liquid from the liquid supply assembly 26 to the spray tip 12. As discussed above, the liquid supply assembly 26 includes a liquid filter assembly 34. In the illustrated embodiment, the liquid filter assembly 34 includes a filter 96, such as a mesh filter cartridge, disposed within a filter housing 98 between the liquid supply coupling 32 and the liquid conduit 36. However, a variety of filter mechanisms may be disposed inside the filter housing 98. As the liquid passes through the spray device 10, the wear resistant material or composition of the spray tip 12 provides resistance against erosion by the liquid, e.g., paint or another liquid coating material. In certain embodiments, the liquid may include particulate matter, such that a two-phase flow of liquid and solid passes through the spray device 10 and the spray tip 12. For example, certain embodiments of paint may be described as particulate paint, which includes both liquid and solid particles. Accordingly, the filter 96 is configured to remove larger particles from the liquid, while the wear resistant material or composition of the spray tip 12 provides resistance against wear by the passing liquid (and any remaining particles).

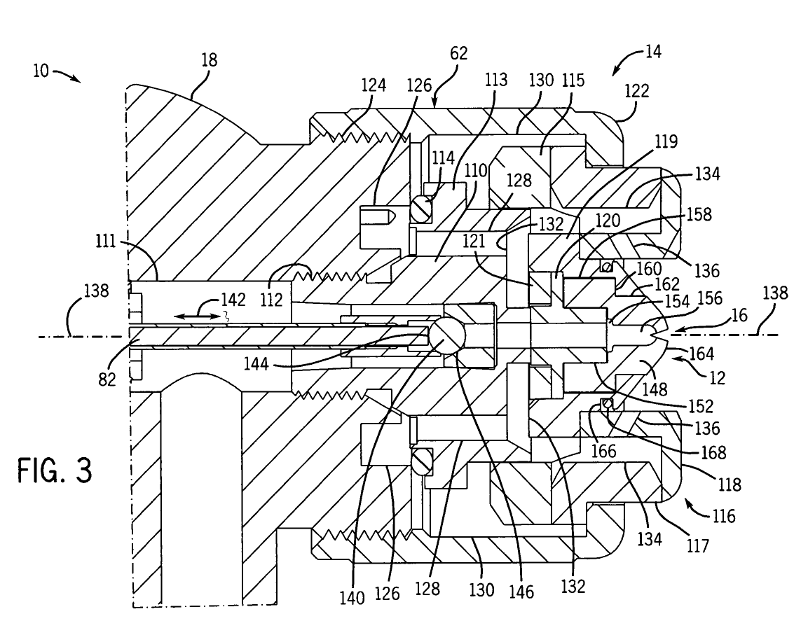

FIG. 3 is a partial cross-sectional view of an embodiment of the spray device 10 as illustrated in FIGS. 1 and 2, further illustrating details of the head assembly 14. In the illustrated embodiment, the air nozzle assembly 62 includes a first annular member 110 threadingly coupled to a central liquid passage 111 via threads 112. The air nozzle assembly 62 also includes a second annular member 113 disposed concentrically about the first annular member 110 and sealed against the body assembly 18 via an o-ring 114. The air nozzle assembly 62 further includes a third annular member 115 disposed concentrically about the second annular member 113, and an air-assisted spray shaping head assembly 116 disposed adjacent the third annular member 115. In certain embodiments, the air-assisted spray shaping head assembly 116 includes one or more fourth annular members, e.g., two concentric members 117 and 118. The air nozzle assembly 62 also may include one or more adapters, bushings, washers, or other structures between the head assembly 116 and the spray tip 12. For example, the illustrated embodiment includes an outer holder 119 disposed about the spray tip 12, an inner bushing or adapter 120 disposed at least partially into the spray tip 12, and a rear washer 121 disposed against a rear side of the adapter 120 flush with a rear side of the outer holder 119. Finally, the air nozzle assembly 62 includes an outer casing or retainer 122 disposed about the members 110, 113, 115, 116, 119, 120, and 121 and threadingly coupled to the body assembly 18 via threads 124.

The illustrated members 110, 113, 115, 116, 119, 120, 121, and 122 define or include a plurality of air passages 126, 128, 130, 132, and 134 leading from the air passage 60 in the body assembly 18 to one or more air jets 136 disposed in the air-assisted spray shaping head 116. In the illustrated embodiment, a plurality of these air jets 136 are angled toward a center line or center plane 138 of the spray tip 12. In operation, the air jets 136 provide air flow or pressure to shape the liquid spray that develops downstream of the fluid output orifice 16. For example, the air jets 136 may be configured to shape the spray in a generally flat or sheet-like pattern. However, the illustrated embodiment does not include air atomization jets, but rather the spray is formed substantially by liquid atomization from the fluid output orifice 16 of the spray tip 12. In alternative embodiments, the spray device 10 may include one or more air atomization jets to cooperate with the spray tip 12, thereby creating a desired spray via both liquid atomization and air atomization.

In operation, the valve shaft 82 moves linearly along the axis 136 to open and close a ball valve member 140 as indicated by arrow 142. Specifically, the ball valve member 140 is disposed between an end 144 of the valve shaft 82 and a wedge-shaped cavity or passage 146 within the first annular member 110 of the air nozzle assembly 62. Accordingly, the flow of liquid through the head assembly 14 to the spray tip 12 is controlled by biasing or releasing the ball valve member 140 relative to the wedge-shaped cavity or passage 146. In other embodiments, the end 144 of the valve shaft 82 may have a wedge-shaped tip (e.g., a needle valve), which can be removably biased against the wedge-shaped cavity or passage 146 to open and close the flow of liquid through the head assembly 14. Eventually, the fluid passes through the spray tip 12, and the fluid output orifice 16 ejects a spray of the fluid.

As illustrated in FIG. 3, the spray tip 12 has a generally annular or hollow structure 148. The internal geometry of the illustrated structure 148 has a first cylindrical passage 152, a second cylindrical passage or transition 154, and a third cylindrical passage 156 leading to the fluid output orifice 16. The external geometry of the illustrated structure 148 includes a first cylindrical portion 158, a step portion 160 leading to a second cylindrical portion 162, and a semispherical or convex face 164. However, the internal and external geometries of the structure 148 may be adapted to any particular spray device 10. In addition, the illustrated structure 148 may be manufactured from a variety of wear resistant materials, such as tungsten carbide. The manufacture of the illustrated structure 148 also may include a variety of manufacturing processes, including microblasting the fluid output orifice 16.

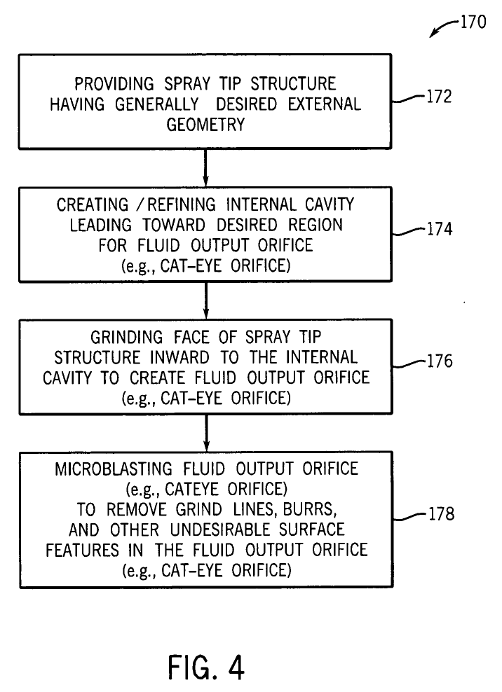

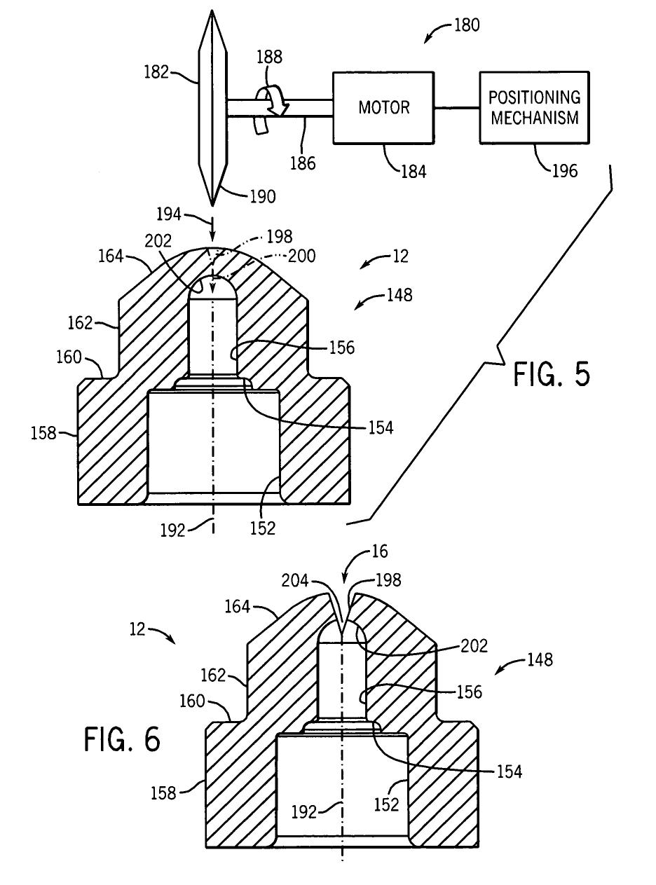

FIG. 4 is a flow chart of an embodiment of a process 170 for manufacturing the spray tip 12 having the fluid output orifice 16 as illustrated in FIGS. 1-3. In the illustrated embodiment, the process 170 includes providing a spray tip structure having a generally desired external geometry (block 172). For example, block 172 may include molding, casting, or generally forming the structure 148 having the first cylindrical portion 158, the step portion 160, the second cylindrical portion 162, and the convex face 164 as illustrated in FIG. 3. By further example, the block 172 may involve casting a wear resistant material, such as tungsten carbide, into the external shape of the structure 148. The process 170 also may include creating or refining an internal cavity leading toward a desired region for a fluid output orifice, such as a cat-eye orifice, in the spray tip structure (block 174). For example, the block 174 may include drilling or machining the first cylindrical passage 152, the second cylindrical passage or transition 154, and the third cylindrical passage 156 as illustrated in FIG. 3. However, the interior of the structure 148 may be generally formed during the molding or casting process discussed above. At block 176, the illustrated process 170 also includes grinding a face of the spray tip structure inward to the internal cavity to create a fluid output orifice, such as a cat-eye orifice. For example, the block 176 may involve applying an angled grinding wheel against the convex face 164 of the structure 148 as illustrated in FIG. 3. An embodiment of block 176 of the process 170 is discussed in further detail below with reference to FIG. 5.

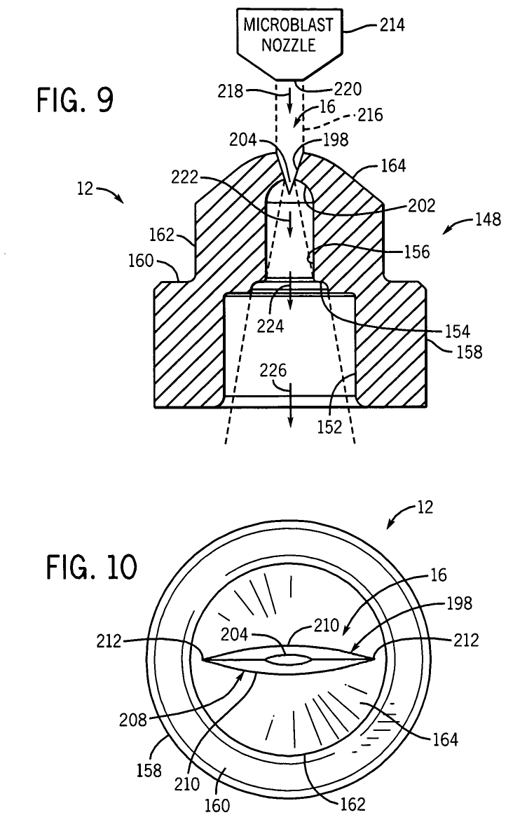

At block 178, the illustrated process 170 may further include microblasting the fluid output orifice, such as the cat-eye orifice, to remove grind lines, burrs, and other undesirable surface features in the fluid output orifice. For example, as discussed in further detail below with reference to FIG. 9, a stream of micron size particles or microblast media, such as aluminum oxide or silicon carbide particles, may be applied to the fluid output orifice 16 and the passages 152, 154, and 156. The stream of micron size particles may be directed into, through, or against the fluid output orifice 16 from a variety of directions and orientations, such as the outer side or the inner side of the fluid output orifice 16. For example, the micron size particles or microblast media may include particles having a diameter in a general range of less than 100 microns, or less than 75 microns, or less than 50 microns in diameter. In certain embodiments, the microblast media may have a particle diameter range of between about 10 and 60 microns, or between about 17.5 and 50 microns. However, a variety of microblast media, particle size distribution, blasting speed, blasting time, blasting pressure, blasting distance between the orifice 16 and a blast nozzle, blast nozzle dimensions, and other microblasting parameters may be varied depending on the particular spray tip 12 and the fluid output orifice 16.

FIG. 5 is a cross-sectional view of an embodiment of the general structure 148 of the spray tip 12 as illustrated in FIGS. 1-3, further illustrating a grinding mechanism 180 exploded from a desired region for the fluid output orifice 16. In the illustrated embodiment, the grinding mechanism 180 includes a grinding wheel or disc 182 coupled to a motor 184 via a shaft 186. Thus, the motor 184 is operable to rotate the grinding wheel 184 about an axis of the shaft 186, as illustrated by arrow 188. In certain embodiment, the grinding wheel 182 may be formed of a highly abrasive material. The grinding wheel 182 also may have a generally V-shaped outer perimeter or grinding surface 190. Thus, the grinding mechanism 180 may be moved in a controlled manner toward the convex face 164 of the structure 148, such that the V-shaped grinding surface 190 generally engages the convex face 164 along the central or lengthwise axis 192 of the structure 148 as illustrated by arrow 194. In certain embodiment, the grinding mechanism 180 may include a positioning mechanism 196 to enable precise movement and positioning of the V-shaped grinding surface 190 relative to the axis 192 of the structure 148. As the grinding wheel 182 engages the structure 148, the V-shaped grinding surface 190 progressively forms an increasing larger V-shaped slot or groove 198 extending deeper into the structure 148 as indicated by arrow 200. Eventually, the grinding surface 190 of the grinding wheel 192 expands and deepens the V-shaped slot or groove 198 into a top portion 202 of the third cylindrical passage 156.

FIG. 6 is a cross-sectional view of an embodiment of the spray tip 12 as illustrated in FIGS. 1-3 and 5, further illustrating the V-shaped slot or groove 198 intersecting with the top portion 202 of the third cylindrical passage 156 after the grinding procedure 176 by the grinding wheel 182 as illustrated in FIGS. 4 and 5. In the illustrated embodiment, the fluid output orifice 16 includes the V-shaped slot or groove 198 and an opening 204 at the intersection between the top portion 202 of the third cylindrical passage 156 and the V-shaped slot or groove 198. For example, the opening 204 may have a generally oval or cat-eye shaped perimeter defined by a generally concave or semispherical interior surface of the top portion 202 and the V-shaped slot or groove 198. As discussed above with reference to FIG. 4, a microblasting procedure 178 may be employed to remove various grind lines, burrs, and other undesirable surface features disposed on the V-shaped slot or groove 198 and the opening 204 of the fluid output orifice 16.

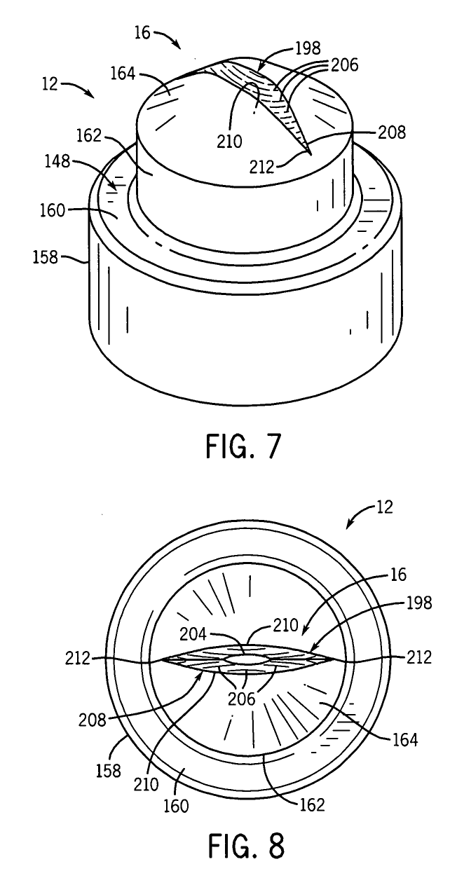

FIG. 7 is a perspective view of an embodiment of the spray tip 12 as illustrated in FIGS. 1-3 and 5-6, further illustrating grind lines, burrs, and other undesirable surface features 206 prior to the microblasting procedure 178 of the process 170 as illustrated in FIG. 4. For example, the grind lines, burrs, or other undesirable surface features 206 may have a generally curved path along the V-shaped slot or groove 198 due to the generally circular or annular path of the V-shaped grinding surface 190 of the grinding wheel 192 as discussed above with reference to FIGS. 4 and 5. In addition, the V-shaped slot or groove 198 may have a generally cat-eye shaped outer perimeter 208 extending along the convex face 164 of the structure 148. For example, the cat-eye shaped outer perimeter 208 may have opposite or symmetrically opposed curved portions 210 leading to opposite edges 212. In other words, the cat-eye shaped outer perimeter 208 may be generally widest at the central region between the opposite edges 212, while the curved portions 210 curve inwardly toward one another and intersect at the opposite edges 212. In certain embodiments, the V-shaped slot or groove 198, the opening 204, and the cat-eye shaped outer perimeter 208 of the fluid output orifice 16 facilitate a generally flat or substantially flattened spray pattern downstream from the spray tip 12.

FIG. 8 is a top view of an embodiment of the spray tip 12 as illustrated in FIGS. 1-3 and 6-7, further illustrating the grind lines, burrs, and other undesirable surface features 206 along the V-shaped slot or groove 198 of the fluid output orifice 16. As illustrated, the grind lines, burrs, and other undesirable surface features 206 extend from the central opening 204, e.g., cat-eye shaped opening, to the cat-eye shaped outer perimeter 208. In addition, the opening 204 may have various surface imperfections associated with the grinding procedure 176 as discussed above with reference to FIGS. 4 and 5.

FIG. 9 is a cross-sectional view of the spray tip 12 as illustrated in FIGS. 1-3 and 6-8, further illustrating an embodiment of the microblasting procedure 178 as illustrated in FIG. 4. In the illustrated embodiment, a microblast nozzle 214 is operable to discharge or generally direct a microblast media stream 216 in a direction 218 toward the fluid output orifice 16 to remove the various grind lines, burrs, and other undesirable surface features 206 as illustrated in FIGS. 7 and 8. For example, the microblast media stream 216 may include micron size particles of aluminum oxide, silicon carbide, or other suitable blast media. In addition, the microblast nozzle 214 may have a variety of dimensions, shapes, flow velocities, pressures, transport media, positioning mechanisms, and other features to control the characteristics of the microblast media stream 216 and the refinement or smoothening of the fluid output orifice 16. For example, a nozzle orifice 220 of the microblast nozzle 214 may have a geometry that is circular, oval, cat-eye shaped, rectangular, square, triangular, hexagonal, and so forth. In addition, the nozzle orifice 220 may have a variety of diameters, widths, or other dimensions, which control the general diameter or width of the microblast media stream 216. In addition, the microblast nozzle 214 may be disposed at a variety of distances away from the fluid output orifice 16, thereby further adjusting the application of the microblast media stream 216 to the fluid output orifice 16. As illustrated in FIG. 9, the microblast media stream 216 generally passes through the fluid output orifice 16 and subsequently through the passages 156, 154, and 152 as indicated by arrow 222, 224, and 226, respectively. Thus, the microblast media stream 216 may substantially improve the surface characteristics of the fluid output orifice 16 as well as the passages 152, 154, and 156.

In the illustrated embodiment, the microblast media stream 216 is oriented at a downstream position relative to the fluid output orifice 16. However, in other embodiments, the microblast media stream 216 may be oriented at an upstream position relative to the fluid output orifice 16. In other words, the microblast media stream 216 may be directed through the spray tip 12 in the same direction as fluid flows through the spray tip 12 during operation of the spray device 10. Moreover, the angle and position of the microblast media stream 216 may be varied during the microblasting procedure 178. For example, the microblast media stream 216 may be rotated circumferentially around the central flow axis of the spray tip 12, or pivoted radially from left to right, or moved axially inward and outward, or a combination thereof. In some embodiments, a plurality of microblast media streams 216 may be simultaneously directed toward the fluid output orifice 16. For example, microblast media streams 216 may be directed from different angles and positions relative to the fluid output orifice 16 on the upstream side, or the downstream side, or both. The microblast media stream 216 also may have a continuous or non-continuous velocity. In other words, the microblast media stream 216 may be pulsed or accelerated/decelerated in an intermittent manner.

FIG. 10 is a top view of an embodiment of the spray tip 12 as illustrated in FIGS. 1-3 and 6-9, further illustrating the fluid output orifice 16 without the various grind lines, burrs, and other undesirable surface features 206 after the microblasting procedure 178 by the microblast nozzle 214 as illustrated in FIGS. 4 and 9. In the illustrated embodiment, the V-shaped slot or groove 198 and the opening 204 of the fluid output orifice 16 have a substantially improved surface quality, which may substantially improve the general spray pattern or uniformity of the fluid spray forming downstream from the spray tip 12. In addition, the microblasting procedure 178 may substantially improve the general surface geometry, dimensions, curvature, or cat-eye shaped features of the V-shaped slot or groove 198 and the opening 204. In other words, the microblasting procedure 178 may simultaneously remove surface imperfections, such as the grind lines, burrs, and other undesirable surface features 206, while also substantially removing or eliminating any breaks, steps, variations, or zigzagging patterns along the cat-eye shaped outer perimeter 208 of the V-shaped slot or groove 198 and the cat-eye shaped outer perimeter of the opening 204.

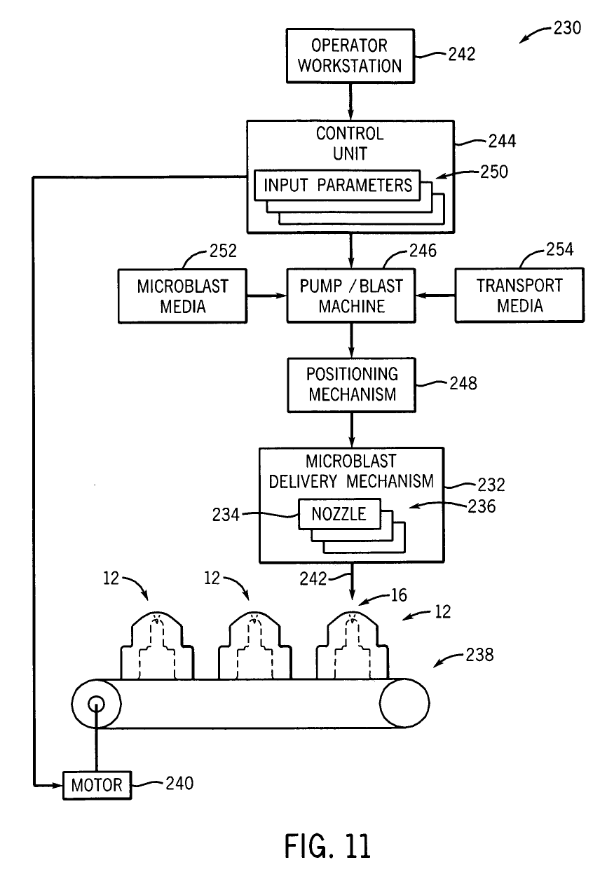

FIG. 11 is a block diagram of an embodiment of a system for microblasting or generally manufacturing the spray tip 12 as illustrated in FIGS. 1-10. In the illustrated embodiment, a system 230 includes a microblast delivery mechanism 232 configured to microblast the fluid output orifice 16 of the spray tip 12 with a selected nozzle 234 from a plurality of different nozzles 236. For example, a series of spray tips 12 may be disposed one after another along a conveyer belt 238 coupled to a motor 240. Thus, the microblast delivery mechanism 232 may sequentially apply a microblast media stream 242 toward the fluid output orifice 16 of each spray tip 12. In addition, the system 230 may include an operator work station 242 coupled to one or more control units 244. The control unit 244 can selectively control the motor 240 of the conveyor belt 238.

The control unit 244 also can control a pump/blast machine 246 and a positioning mechanism 248 coupled to the microblast delivery mechanism 232. For example, the control unit 244 may include a variety of input parameters 250, such as speed, timing, and stop/start positions of the conveyor belt 238. In addition, the input parameters 250 may include timing, duration, pressure, speed, flow rate, width, microblast media characteristics, nozzle type, and other characteristics or parameters affecting the microblast media stream 242. The system 230 may utilize a variety of different microblast media 252 and transport media 254, which are generally pumped or transferred through the pump/blast machine 246 into the microblast delivery mechanism 232 and out through the selected nozzle 234. For example, as discussed above, the microblast media 252 may include micron size particles of aluminum oxide, silicon carbide, and so forth. The transport media 254 may include air, water, or another liquid or gas suitable for the other input parameters 250 of the particular microblast procedure. The positioning mechanism 248 may include a robotic arm, a hydraulic mechanism, a pneumatic mechanism, a linear positioning mechanism coupled to an electric motor, a rail or guide structure, a computer aided design (CAD) system, a computer aided manufacture (CAM) system, or other suitable devices to position the selected nozzle 234 in an appropriated position relative to the fluid output orifice 16 of the spray tip 12. For example, the input parameters 250 may include a distance between the selected nozzle 234 and the fluid output orifice 16.

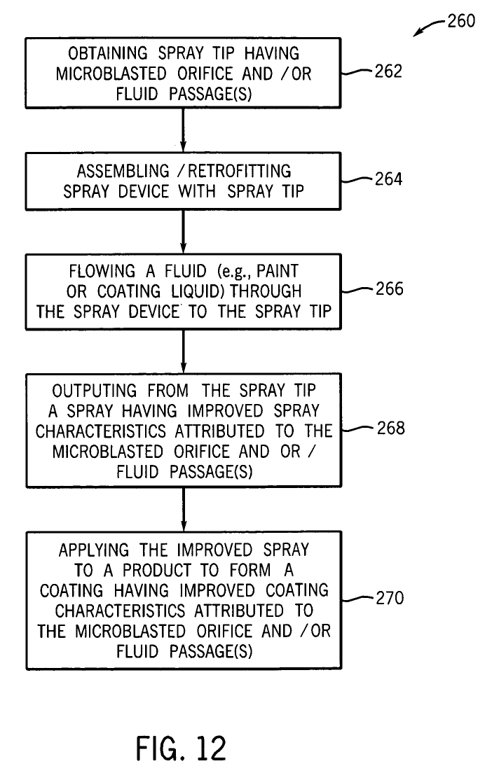

FIG. 12 is a flow chart of an embodiment of a process 260 for using or operating the spray device 10 having the spray tip 12 as illustrated in FIGS. 1-11. In the illustrated embodiment, the process 260 includes obtaining a spray tip having a microblasted orifice and/or fluid passages (block 262). For example, the block 262 may include manufacturing the spray tip 12 as illustrated in FIGS. 4 and 11, or generally obtaining a previously manufactured spray tip 12 and microblasting the fluid output orifice 16, or simply obtaining the spray tip 12 having the microblasted fluid output orifice 16. The process 260 also includes assembling or retrofitting the spray device with the spray tip having the microblasted orifice and/or fluid passages (block 264). For example, the block 264 may involve refining a preexisting spray device 10 with the spray tip 12 subject to a microblast procedure, such as discussed in detail above with reference to FIGS. 4, 9, and 11. Thus, the spray device 10 having the spray tip 12 may have a substantially refined or smoothened fluid output orifice 16, such as illustrated in FIG. 10.

At block 266, the process 260 may further include flowing a fluid (e.g., paint or another coating liquid) through the spray device to the spray tip having the microblasted orifice and/or fluid passages. At block 268, the process 260 includes outputting from the spray tip a spray having improved spray characteristics attributed to the microblasted orifice and/or fluid passages. For example, the spray tip 12 of the spray device 10 may produce a generally uniform shape, density, or distribution of atomized fluid (e.g., paint droplets) downstream of the microblasted orifice 16 and/or fluid passages 152, 154, and 156. Again, the improved spray characteristics are largely due to the removal of the grind lines, burrs, and other undesirable surface features 206 as illustrated in FIGS. 7 and 8 as well as other improvements in the geometry of the fluid output orifice 16. At block 270, the process 260 includes applying the improved spray to a product to form a coating having improved coating characteristics attributed to the microblasted orifice and/or fluid passages. For example, the improved coating characteristics may include a generally uniform thickness or distribution of the coating on the particular product, thereby improving the overall appearance, durability, adherence, and other properties of the coating.

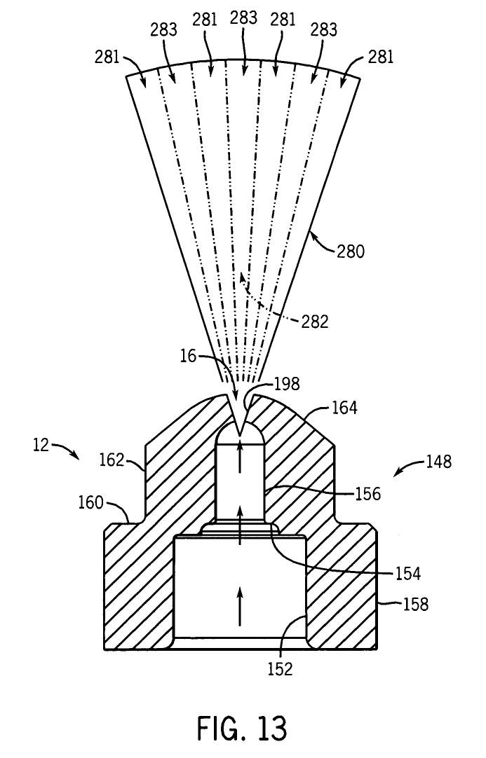

FIG. 13 is a cross-sectional view of an embodiment of the spray tip 12 after microblast treatment of the fluid output orifice 16 as illustrated in FIGS. 1-4 and 9-12, further illustrating a substantially improved spray 280 (solid lines) without the undesirable droplet distribution or fingerlike patterns 282 (dashed lines) associated with the grind lines, burrs, and undesirable surface features 206 in the fluid output orifice 16 as illustrated in FIGS. 7 and 8. In other words, the improved spray 280 has a generally uniform or substantially improved distribution or density of atomized fluid, rather than regions or patterns of relatively dense atomized fluid (e.g., liquid droplets) and relatively sparse atomized fluid (e.g., liquid droplets). For example, the fingerlike patterns 282 may include fingers or rays 281 of relatively densely distributed droplets, and other fingers or rays 283 of relatively sparsely distributed droplets. Again, the microblast treatment of the fluid output orifice 16 substantially or entirely removes these variations, fingerlike patterns, or non-uniform distributions of atomized fluid 282. Thus, the atomized fluid within the improved spray 280 is more evenly distributed downstream of the spray tip 12.

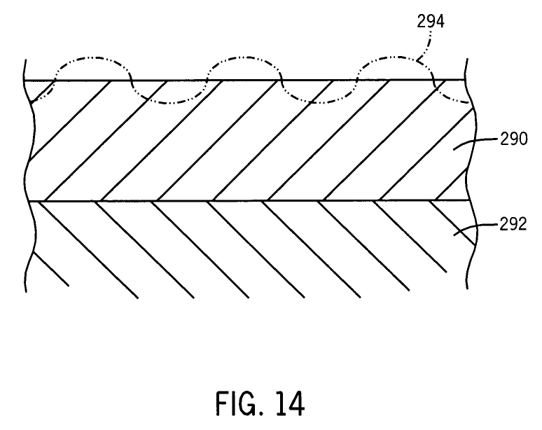

FIG. 14 is a partial cross-sectional view of an embodiment of a uniform spray coating or finishing layer 290 (solid line) applied on a product 292 by the improved spray 280 as illustrated in FIG. 13, further illustrating the substantial or entire removal of previous defects or coating variations 294 (dashed line) prior to the microblast treatment of the fluid output orifice 16 as illustrated in FIGS. 4 and 9-13. In the illustrated embodiment, the uniform spray coating or finishing layer 290 has a generally uniform thickness along the surface of the product 292, rather than having varying deeper and shallower applications of the coating material as indicated by dashed line 294. Again, the previous defects or surface variations 294 may be attributed to the variations or fingerlike patterns 282 resulting from the grind lines, burrs, and other surface variations in the fluid output orifice 16 as illustrated in FIGS. 7 and 8. Upon removal of these grind lines, burrs, and other undesirable surfaces features 206, the fluid output orifice 16 produces the substantially improved or more uniform spray 280 without the fingerlike patterns 282 as illustrated in FIG. 13. As a result, the uniform spray coating or finishing layer 290 has a substantially improved or more uniform geometry, surface appearance, and overall quality at least partially or entirely attributed to the microblast treatment of the fluid output orifice 16.

In certain embodiments, the product 292 of FIG. 14 may include all or part of a vehicle, such as an automobile, an aircraft, a watercraft, a bus, a locomotive, a bicycle, a motorcycle, a trailer, and so forth. The product 292 also may include an electric motor, a combustion engine, a turbine, or another power source. Furthermore, the product 292 may include a consumer product, an industrial product or machine, a commercial product, and so forth. For example, the product 292 may include toys, computers, electronics, audio/video equipment, household appliances, plumbing fixtures, sinks, toilets, light fixtures, buildings, walls, furniture, tools, welding units, and so forth. As a result, the finishing layer 290 may include one or more layers of paint, stain, ceramic, clear coat, and other desired surface coatings.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A method, comprising:
microblasting a spray tip of a spray device to refine spray characteristics of the spray tip.

2. The method of claim 1, wherein microblasting comprises substantially removing grind lines, burrs, or other surface imperfections disposed along a liquid flow path of the spray tip.

3. The method of claim 1, wherein microblasting the spray tip of the spray device to refine spray characteristics comprises substantially removing a finger like pattern in a spray provided by the spray tip.

4. The method of claim 1, wherein microblasting comprises impacting a stream of micron size particles against a fluid output orifice of the spray tip.

5. The method of claim 1, wherein microblasting comprises impacting particles of aluminum oxide or silicon carbide against a fluid output orifice of the spray tip.

6. The method of claim 1, wherein microblasting comprises impacting a microblast media into a cat-eye shaped orifice disposed in a V-shaped groove of the spray tip.

7. The method of claim 1, wherein microblasting comprises impacting a stream of microblast media against a machined flow surface of a tungsten carbide spray tip.

8. The method of claim 1, wherein microblasting comprises directing a stream of microblast media toward an orifice in a plurality of orientations.

9. The method of claim 1, wherein microblasting comprises directing a stream of microblast media toward an orifice at a downstream position, or an upstream position, or both downstream and upstream positions relative to the orifice.

10. The method of claim 1, comprising assembling the microblasted spray tip into the spray device.

11. A method, comprising:
outputting a substance from a microblasted output orifice of a spray device to create a spray having characteristics at least partially attributed to a microblast treatment of the microblasted output orifice; and
applying the spray onto a surface of a product to create a coating having characteristics at least partially attributed to the microblast treatment.

12. The method of claim 11, wherein outputting comprises spraying with substantially improved spray uniformity at least partially attributed to the microblast treatment.

13. The method of claim 11, wherein applying comprises coating the product with substantially improved coating uniformity at least partially attributed to the microblast treatment.

14. The method of claim 11, comprising directing at least one air jet toward the substance outputting from the microblasted output orifice.

15. The method of claim 14, wherein directing the at least one air jet comprises atomizing the substance and shaping the spray.

16. A system, comprising:
a spray tip comprising a microblasted output orifice configured to create a substantially uniform spray at least partially attributed to a smooth microblasted surface characteristic of the microblasted output orifice.

17. The system of claim 16, wherein the spray tip comprises tungsten carbide.

18. The system of claim 16, wherein the microblasted output orifice comprises a cat-eye shaped opening and an adjacent diverging section.

19. The system of claim 18, wherein the adjacent diverging section comprises a V-shaped groove having the smooth microblasted surface characteristic.

20. The system of claim 16, comprising a spray coating gun having the spray tip disposed in a head assembly, wherein the spray coating gun comprises a handle, a trigger, a liquid valve coupled to the trigger, and one or more liquid passages between the liquid valve and the spray tip.

21. A system, comprising:
a spray coating device, comprising:
a body having a handle and a trigger coupled to a liquid valve; and
a head coupled to the body, wherein the head comprises a removable spray tip having a liquid passage extending to a liquid exit orifice, wherein the liquid exit orifice comprises a substantially smooth microblasted surface configured to create a substantially uniform spray.

22. The system of claim 21, wherein the liquid exit orifice comprises a V-shaped groove and a cat-eye shaped opening in the V-shaped groove.
